(19) United States
(12) Patent Application Publication
(10) Pub. No.: US 2005/0178537 A1
(43) Pub. Date: Aug. 18, 2005

(54) Air-conditioning system for a motor vehicle

(75) Inventors: Oliver Horn, Munchen (DE); Wolfgang Kramer, Munchen (DE); Noureddine Khelifa, Munchen (DE)

Correspondence Address: DOBRUSIN & THENNISCH PC, 29 W LAWRENCE ST, SUITE 210, PONTIAC, MI, 48342, US

(73) Assignee: Webasto AG, Stockdorf (DE)

(21) Appl. No.: 10/780,119

(22) Filed: Feb. 17, 2004

(51) Int. Cl. B60H 1/00

(52) U.S. Cl. 165/202

(57) ABSTRACT

An air-conditioning system for a motor vehicle has a coolant circuit which comprises an electrically driven compressor, a condenser, an expansion valve and a latent cold holdover. Heat extracted from the latent cold holdover by the coolant circuit. This is referred to as charging the latent cold holdover. In addition, an air cooling mechanism is provided that extracts heat from the air and is fed to the latent cold holdover. The air-conditioning system can thus be particularly compact and effective as an air-conditioning system for operation in a stationary vehicle.

### TECHNICAL FIELD

The present invention relates to air conditioning systems, and particularly systems for use in a motor vehicle.

### BACKGROUND

The invention relates to an air-conditioning system, particularly one for motor vehicle having a coolant circuit which comprises a compressor, a condenser, an expansion valve and a latent cold holdover, from which heat can be extracted by the coolant circuit. This extraction of heat is referred to as charging. In addition, the air-conditioning system comprises an air cooling mechanism which extracts heat from the air and feeds the heat to the latent cold holdover. This supply of heat is referred to as discharging. Such an air-conditioning system is used in particular for motor vehicles. It is used in such vehicles in particular as an air-conditioning system for operation in a stationary vehicle.

DE 198 52 541 C1 discloses an air-conditioning system for operation in a stationary motor vehicle, having a coolant circuit which comprises a compressor, vaporizer, a collector and at least one ice storage component. The ice storage component is composed of a vaporizer with expansion element and an ice store which surrounds it. In addition, a further vaporizer with an expansion element connected in parallel with the at least one ice storage unit, being possible use corresponding switch-over valves to control whether the coolant flows through the further vaporizer or the vaporizer of the ice storage component. The compressor is driven mechanically by means of a drive engine/motor of the vehicle and can be coupled to it by means of a magnetic coupling via a V belt.

One object of the invention is air-conditioning system which is to provide compact suitable for cooling a vehicle in the stationary operating mode of the vehicle.

Such object is achieved, in whole or in part, by the features of the independent patent claim. Further, advantageous refinements of the invention are characterized, without limitation, in the subclaims.

### SUMMARY OF THE INVENTION

The invention is defined by an air-conditioning system for a motor vehicle having a first coolant circuit which comprises an electrically driven compressor, a condenser, an expansion valve and latent cold holdover, from which heat is extracted by the coolant circuit, and having an air cooling mechanism which extracts heat from the air and feeds the heat to the latent cold holdover. In one embodiment, the power of the compressor can be set by the electrically driven compressor independently of the rotational speed of a drive shaft of the motor vehicle, and if appropriate electrical energy can also be made available to the compressor independently of the drive of the motor vehicle, As result, a predefinable quantity of heat can be extracted from the latent cold holdover in a simple manner even in extreme heat.

In a further embodiment, the air-conditioning system is arranged in the motor vehicle and its compressor is driven by the motor vehicle drive train, that is to say for example drive shaft or the crankshaft. The latent cold holdover of an air-conditioning system can be charged quickly even if the compressor of the primary air-conditioning system is operated at its power limit.

The latent cold holdover is also distinguished by a very high specific cold capacity. This has the advantage that the air-conditioning system can be embodied in a very compact fashion. It can extract a large amount of heat from the air in particular in the stationary operating mode of the vehicle when the drive shaft is not rotating.

In an advantageous refinement of the invention, the air-conditioning system has a second coolant circuit which comprises a pump, the latent cold holdover and a heat exchanger, via which heat is extracted from the air and the heat is then fed to the latent cold holdover. This has the advantage that the heat exchanger can be arranged at any desired location in the motor vehicle.

In a further advantageous refinement of the invention, a blower which passes the air stream through the heat exchanger and which simultaneously passes the air stream through a heating element is assigned to the heat exchanger. This has the advantage that only one blower is necessary in order to cool air, on the one hand, and heat air, on the other.

It is particularly advantageous if the heating element is a heating heat exchanger through which a fluid flows which can be heated by a fuel heater. A particularly high heating power is possible using such a heating element.

In a further advantageous refinement of the invention, the latent cold holdover is arranged so that the air to be cooled flows through the latent cold holdover and is cooled in the process. As a result, the air-conditioning system can be particularly compact. In this context it is particularly advantageous if the coolant circuit comprises a plurality of latent cold holdovers. In this way, cooling can take place at a plurality of locations on the motor vehicle. This is particularly advantageous in vehicles which have both a driver's cab and separate sleeping/living cab.

In a further advantageous refinement of the invention, the air-conditioning system is assigned a generator which is driven by a drive shaft of a drive of the internal combustion engine and in this way makes available the electrical energy of the electrically driven compressor. The electrically driven compressor can thus be operated at high power during the driving mode.

### BRIEF DESCRIPTION OF THE FIGURES

Exemplary embodiments of the invention are explained below with reference to the schematic drawings, in which:

FIG. 1 shows a first embodiment of the air-conditioning system,

FIG. 2 shows a second embodiment of the air-conditioning system,

FIG. 3 shows a third embodiment of the air-conditioning system,

FIG. 4 shows a fourth embodiment of the air-conditioning system,

FIG. 5 shows a fifth embodiment of the air-conditioning system and

FIG. 6 shows a sixth embodiment of the air-conditioning system.

### DETAILED DESCRIPTION OF THE INVENTION

Elements of the same design and function are characterized with the same reference numbers throughout the figures.

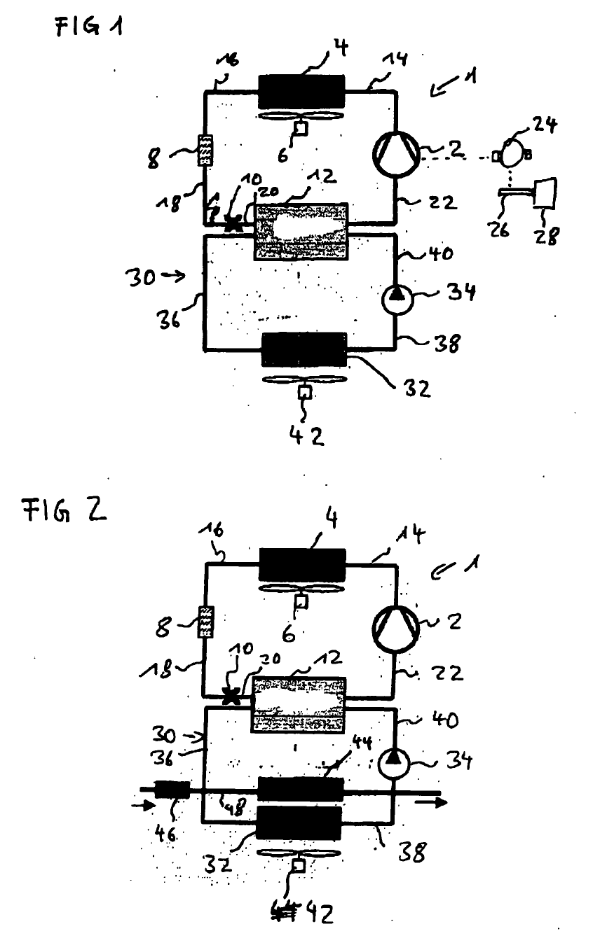

An air-conditioning system (FIG. 1) arranged in a motor vehicle, particularly in utility vehicle. It has a coolant circuit 1 which comprises an electrically driven compressor 2, a condenser 4, to which a condenser/blower is assigned, a collector 8, an expansion valve 10 and a latent cold holdover 12. The expansion valve 10 may be controllable or else may be only a restrictor. The compressor 2 is connected at the output end via a first line 14 to the condenser 4 which is in turn connected at the output end via a second line 16 to the collector 8, which also preferably comprises drier. The collector 8 is connected via a third line 18 to the expansion valve 10 which is connected at the output end via a fifth line 22 to the latent cold holdover. The latent cold holdover 12 is connected at the output end via a fifth line 22 to the compressor 2 at the input end. Electrical energy is preferably fed to the electrically driven compressor 2 from a generator 24 which is driven by a drive shaft 26 of a drive 28 of the motor vehicle. The drive 28 may include, for example, an internal combustion engine (whether gasoline, diesel, fuel cell powered or otherwise). The electrically driven compressor can, however, also be fed electrical energy in other ways, for example by means of a fuel cell or some other element which outputs electrical energy, for example a battery. In this context, the electrical energy can be fed to the electrically driven compressor from any desired combination of the elements which are specified by way of example. Given a corresponding configuration of these elements it is possible for the electrically driven compressor 2 to be operated with a power which is sufficient, even under extreme operating conditions, to extract the desired quantity of heat from the latent cold holdover 12.

While the electrically driven compressor is operating, the coolant, which may be, for example, R134a, CO₂, or otherwise, is compressed, as a result of which its temperature increases. The condenser 4 is such that, by its interaction with the condenser/blower 6, heat is extracted from the coolant by the air flowing through the condenser 4. The coolant which is cooled and liquefied in this way flows via the second line 16 on to the collector 8 and from there via the third line 18 and to the expansion valve 10 by means of which it expanded to lower pressure, causing the temperature of the coolant to drop steeply. The coolant then flows to the latent cold holdover 12 and extracts heat from the cold holdover medium there by vaporizing the coolant. The coolant which is then gaseous again flows via the fifth line 22 on to the electrically driven compressor 2 and is compressed there again.

The high specific refrigerating capacity of the latent cold holdover 12 is due essentially to the fact that energy extracted from the cold holdover medium in the latent cold holdover by the coolant such that a phase transition from a fluid state to a solid state takes place. The latent cold holdover can thus be compact. It is also cost-effective to manufacture.

If the coolant is a gaseous-containing fluid such as CO₂, the condenser 4 is preferably a gas cooler, and the lines 18, 22 are in contact in an internal heat exchanger, and the collector is arranged in the line 22.

The air-conditioning system comprises a coolant circuit 30 which comprises a heat exchanger 32, a pump 34 and the latent cold holdover 12. The latent cold holdover 12 is connected by means of a sixth line 36 to the heat exchanger 32 which is connected at the output end via a seventh line 38 the pump 34 at the input end. The pump 34 is connected at the output end via an eighth line 40 to the latent cold holdover 12.

The pump 34 is preferably electrically driven and can draw, for example, the electrical energy necessary for it from a battery (not illustrated). The pump 34 pumps the coolant the coolant circuit through the latent cold holdover said coolant feeding heat the latent cold holdover 12 and thus being cooled. The cooled coolant then flows through the sixth line 36 to the heat exchanger 32 to which, under the control of a blower 42, air is fed, said air then outputting heat to the heat exchanger 32 and thus being cooled and contributing to the desired cooling of an interior space of the motor vehicle. The heat exchanger 32 may be arranged in the region of the driver's compartment or else in a sleeping space or living space of the motor vehicle. The heat which is output by the through-flowing air heats up the coolant in the heat exchanger 32 and the coolant which is thus heated up flows via the seventh line 38 to the pump 34 from which it is pumped again into the latent cold holdover 12.

The electrically driven compressor 2 is preferably driven during the driving mode of the motor vehicle and heat is thus extracted from the latent cold holdover 12. During the stationary operating mode of the motor vehicle, the compressor 2 is preferably not driven, and is at most driven with a low electrical power. In the stationary operating mode, the pump 34 is driven as a function of the required refrigerating capacity, and air thus correspondingly cooled in the motor vehicle by the coolant circuit 30.

In a second embodiment (FIG. 2) of the invention, heating element also provided, which is a heating heat exchanger 44 through which a fluids preferably a water/glycol mixture, flows which mixture can be heated by a fuel heater 46 and fed to the heating heat exchanger 44 via ninth line 48. The hearing heat exchanger 44 is arranged such a way that the blower 42 also controls the air flowing through the hearing heat exchanger 44. In this way, both the air flowing through the heating heat exchanger 44 and the air flowing through the heat exchanger 32 can easily be controlled with only one blower 42.

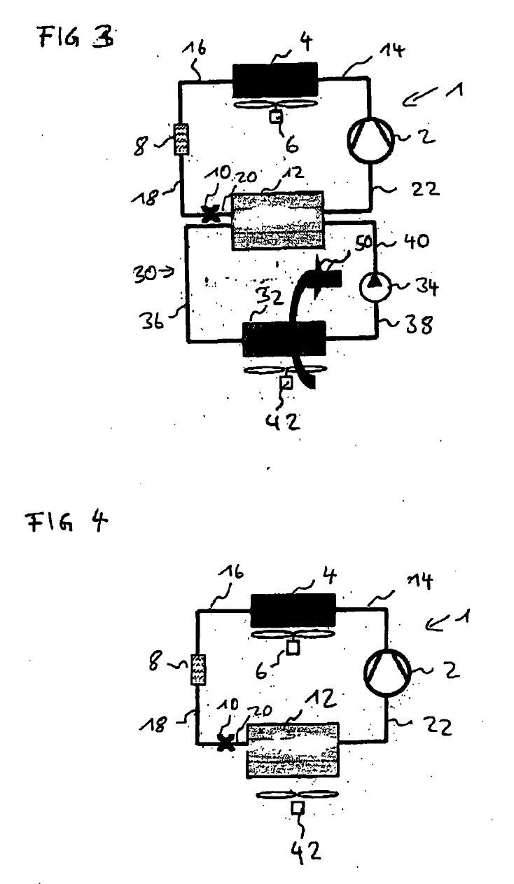

In a third embodiment (FIG. 3) of the air-conditioning system, an air heating element 50 is provided, which may be, for example, a PTC resistor element and thus converts electrical energy into heat, and which is arranged such that the quantity of air which flows past the air heating element 53 is controlled by the blower 42. The air heating element 50 may also be, for example, a fuel/air heater.

In fourth refinement (FIG. 4) of the air-conditioning system, the blower 42 is assigned to the latent cold holdover 12 and controls it in such a way that the air which to be cooled flows through the latent cold holdover or flows past cooling ribs arranged on it, and thus outputs heat to the latent cold holdover 12 and is cooled this way. As result, the air-conditioning system can be particularly compact since it is possible to dispense with the coolant circuit 30; in particular if the air is to be cooled at a plurality of locations on the motor vehicle it is advantageous in this context if the air-conditioning system comprises a plurality of latent cold holdovers 12. This plurality of latent cold holdovers 12 can then be arranged at the corresponding locations on the vehicle and as a result it is possible, for example in the case of a utility vehicle, to arrange a latent cold holdover 12 in the driver's cab and a further latent cold holdover 12 in a separate sleeping space or living space.

In the fourth refinement of the air-conditioning system, according to the refinements according to FIGS. 2 and 3 the fuel heater 46 and the heating heat exchanger 44 or the air heating element 50 may also be present.

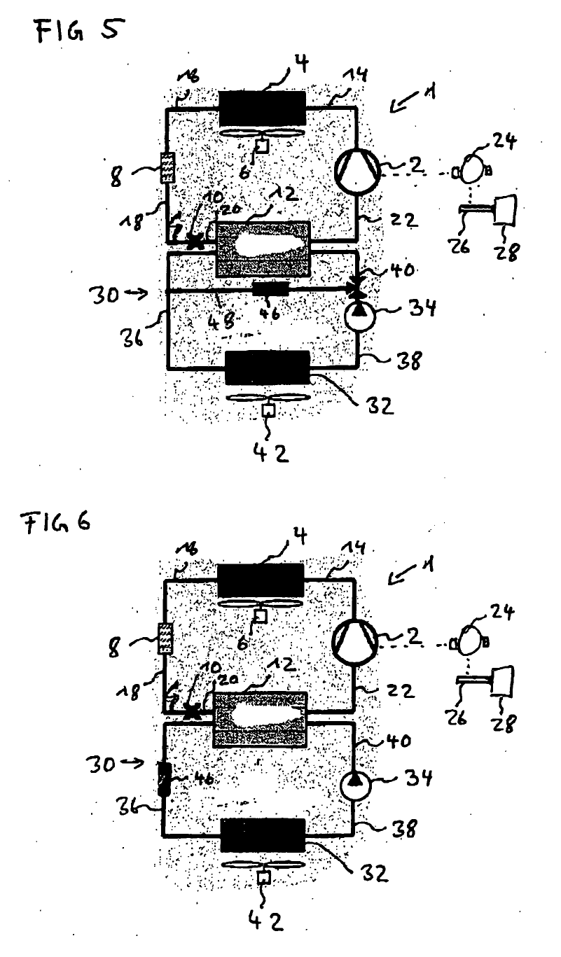

In a fifth refinement of the air-conditioning system (FIG. 5), the fuel heater 46 is arranged in a bypass 48 of the coolant circuit 30. In a sixth refinement of the air-conditioning system (FIG. 6), the fuel heater 46 is coupled to the sixth line 36.

It will be further appreciated that functions or structures of a plurality of components or steps may be combined into a single component or step, or the functions or structures of one-step or component may be split among plural steps or components. The present invention contemplates all of these combinations. Unless stated otherwise, dimensions and geometries of the various structures depicted herein are not intended to be restrictive of the invention, and other dimensions or geometries are possible. Plural structural components or steps can be provided by a single integrated structure or step. For example one or more of the lines may be integrally formed. Alternatively, a single integrated structure or step might be divided into separate plural components or steps. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes.

1. Air-conditioning system for a motor vehicle having a first coolant circuit which comprises an electrically driven compressor, a condenser, an expansion valve and a latent cold holdover, from which heat is extracted by the coolant circuit, and an air cooling mechanism which extracts heat from the air and feeds the heat to the latent cold holdover.

2. Air-conditioning system according to claim 1, wherein the air cooling mechanism comprises a second coolant circuit which comprises a pump, the latent cold holdover and a heat exchanger, via which heat is extracted from the air and is then fed to the latent cold holdover.

3. Air-conditioning system according to claim 2, wherein a blower passes the air stream through the heat exchanger and which simultaneously passes the air stream through heating element is assigned to the heat exchanger.

4. Air-conditioning system according to claim 3, wherein the heating element is a heating heat exchanger through which a fluid flows which can be heated by a fuel heater.

5. Air-conditioning system according to claim 1, wherein the latent cold holdover is arranged such that the air to be cooled flows through the latent cold holdover and is cooled in the process.

6. Air-conditioning system according claim 5, wherein the first coolant circuit comprises a plurality of latent cold holdovers.

7. Air-conditioning system according to claim 1, further comprising a generator which is driven by a drive shaft of a drive of the motor vehicle.

8. Air-conditioning system according to claim 7, wherein the air cooling mechanism comprises a second coolant circuit which comprises a pump, the latent cold holdover and a heat exchanger, via which heat is extracted from the air and is then fed to the latent cold holdover.

9. Air-conditioning system according to claim 8, wherein a blower passes the air stream through the heat exchanger and which simultaneously passes the air stream through heating element is assigned to the heat exchanger.

10. Air-conditioning system according to claim 9, wherein the heating element is a heating heat exchanger through which a fluid flows which can be heated by a fuel heater.

11. Air-conditioning system according to claim 7, wherein the latent cold holdover is arranged such that the air to be cooled flows through the latent cold holdover and is cooled in the process.

12. Air-conditioning system according claim 11, wherein the first coolant circuit comprises a plurality of latent cold holdovers.

13. Air-conditioning system for a motor vehicle having
a first coolant circuit which comprises
an electrically driven compressor,
a condenser,
an expansion valve,
a plurality of latent cold holdovers, from which heat is extracted by the coolant circuit, and
an air cooling mechanism which extracts heat from the air and feeds the heat to the latent cold holdovers,
wherein the air cooling mechanism comprises a second coolant circuit which comprises a pump, at least one latent cold holdover, a heat exchanger and a blower, and wherein the blower passes an air stream through the heat exchanger.
